(19) United States
(12) Patent Application Publication
(10) Pub. No.: US 2019/0039189 A1
(43) Pub. Date: Feb. 7, 2019

(54) FREE FLOWING POTASSIUM ALUMINUM FLUORIDE FLUX AGENT

(71) Applicant: Honeywell International Inc., Morris Plains, NJ (US)

(72) Inventors: Elisabeth Memmel, Seelze (DE); Jessica Maurer, Wunstorf (DE); Christian N. Werner, Hannover (DE)

(21) Appl. No.: 16/000,168

(22) Filed: Jun. 5, 2018

Related U.S. Application Data
(60) Provisional application No. 62/540,754, filed on Aug. 3, 2017.

(51) Int. Cl. B23K 35/362; C01F 7/54

(52) U.S. Cl. CPC B23K 35/362; C01P 2004/61; C01F 7/54

(57) ABSTRACT

The present disclosure provides a free flowing potassium aluminum fluoride (KAlF₄) flux agent (e.g., for plasma flux applications), having improved properties such as a more spherical morphology that is resistant to caking. The potassium aluminum fluoride (KAlF₄) flux agent is rendered free flowing due to the starting temperature and rate of addition of potassium hydroxide when producing KAlF₄.

### CROSS REFERENCE TO RELATED APPLICATIONS

This application claims the benefit under Title 35, U.S.C. § 119(e) of U.S. Provisional Patent Application Ser. No. 62/540,754, entitled FREE FLOWING POTASSIUM ALUMINUM FLUORIDE FLUX AGENT, filed on Aug. 3, 2017, the entire disclosure of which is expressly incorporated by reference herein.

### FIELD OF THE INVENTION

The present disclosure relates generally to a free flowing potassium aluminum fluoride flux agent (e.g., for plasma flux applications).

### BACKGROUND

Brazing operations, which are used in certain manufacturing operations, such as in heat exchanger manufacturing, have traditionally occurred in vacuum furnaces. More recently, a brazing technique known as “controlled atmosphere brazing (CAB)” has become accepted by the automotive industry for making brazed aluminum heat exchangers. Illustrative end uses of CAB brazed aluminum heat exchangers include radiators, condensers, evaporators, heater cores, air charged coolers and inter-coolers.

CAB brazing is preferred over vacuum furnace brazing due to improved production yields, lower furnace maintenance requirements, greater braze process robustness and lower capital cost of the equipment employed.

In a CAB process, a fluxing or flux agent is applied to the pre-assembled component surfaces to be jointed. The flux agent is used to dissociate or dissolve and displace the aluminum oxide layer that naturally forms on aluminum alloy surfaces. The flux agent is also used to prevent reformation of the aluminum oxide layer during brazing and to enhance the flow of the brazing alloy. Illustrative flux agents include alkaline metal or alkaline earth metal fluorides or chlorides.

Fluoride-based fluxes are generally preferred for brazing aluminum or aluminum alloys because they are inert or non-corrosive, as are aluminum and its alloys, yet are substantially water insoluble after brazing, and are commonly used by the automotive industry in the manufacture of aluminum and aluminum alloy heat exchangers.

For plasma flux applications, fluoride-based fluxes (e.g., KAlF₄) are desirably free flowing to allow transportation of the material through an auger without caking and clogging of the equipment. Caking could be prevented by organic additives (e.g., polyethylene glycol) that cover the surface of the material and lead to a smooth, more spherical morphology of the particles. However, the addition of organic additives raises the Volatile Organic Compound (VOC) and Total Organic Carbon (TOC) levels of the flux agent, and therefore are not desired. Organic additives also may have hazardous properties so that handling of the additives should be avoided whenever possible.

What is needed is a fluoride-based flux agent which is an improvement over the foregoing.

### SUMMARY

The present disclosure provides a free flowing potassium aluminum fluoride (KAlF₄) flux agent (e.g., for plasma flux applications), having improved properties such as a more spherical morphology that is resistant to caking. The potassium aluminum fluoride (KAlF₄) flux agent is rendered free flowing due to the starting temperature and rate of addition of potassium hydroxide when producing KAlF₄.

According to an embodiment of the present disclosure, a KAlF₄ flux agent is provided. The KAlF₄ flux agent in the form of particles each having a rounded morphology with a diameter between 5 microns and 100 microns. In a more particular embodiment, the flux agent has a substantially spherical morphology.

According to an embodiment of the present disclosure, a method of producing a flux agent is provided. The method includes: providing a reaction vessel containing water; adding aluminum oxide to the reaction vessel under agitation; adding an aqueous hydrofluoric acid to form a reaction mixture, the aqueous hydrofluoric acid having a concentration between 50 wt. % and 76 wt. %; cooling the reaction mixture to between 40° C. and 70° C.; adding an aqueous potassium hydroxide to the reaction mixture, wherein the aqueous potassium hydroxide has a concentration between 45 wt. % and 50 wt. %, wherein the potassium hydroxide is added to the reaction mixture at a flow rate between 10 g/min and 300 g/min; and spray drying the reaction mixture to produce the flux agent.

In one more particular embodiment of any of the above embodiments, adding the aqueous hydrofluoric acid increases the temperature of the reaction mixture to between 50° C. and 100° C. In one more particular embodiment of any of the above embodiments, the temperature of the reaction mixture is decreased to between 40° C. and 70° C. before adding the potassium hydroxide. In one more particular embodiment of any of the above embodiments, adding the aqueous potassium hydroxide increases the temperature of the reaction mixture to between 60° C. and 100° C. In one more particular embodiment of any of the above embodiments, adding the aqueous potassium hydroxide increases the temperature of the reaction mixture to about 80° C. In one more particular embodiment of any of the above embodiments, an inlet temperature of the spray drying step is between 250° C. and 420° C. and an outlet temperature of the spray drying step is between 125° C. and 165° C. In one more particular embodiment of any of the above embodiments, the inlet temperature is 250° C. and the outlet temperature is 125° C.

According to another embodiment of the present disclosure, a method of producing a flux agent is provided. The method includes: providing a reaction vessel with water; adding aluminum oxide to the water and agitating the water and the aluminum oxide in the reaction vessel; adding an aqueous hydrofluoric acid to form a reaction mixture, wherein the temperature of the reaction mixture increases to between 50° C. and 100° C.; cooling the reaction mixture to between 40° C. and 70° C.; adding an aqueous potassium hydroxide to the reaction mixture, wherein the potassium hydroxide is added at a flow rate between 11 g/min and 13 g/min, and wherein the temperature of the reaction mixture is increased to between 75° C. and 85° C.; and spray drying the reaction mixture to produce the flux agent.

In one more particular embodiment of any of the above embodiments, the aqueous hydrofluoric acid has a concentration between 50 wt. % and 76 wt. %; and wherein the aqueous potassium hydroxide has a concentration between 45 wt. % and 50 wt. %. In one more particular embodiment of any of the above embodiments, the aqueous hydrofluoric acid has a concentration of 50 wt. % and the aqueous potassium hydroxide has a concentration of 49.8 wt. %. In one more particular embodiment of any of the above embodiments, adding the aqueous potassium hydroxide increases the temperature of the reaction mixture to about 80° C. In one more particular embodiment of any of the above embodiments, an inlet temperature of the spray drying step is between 250° C. and 420° C. and an outlet temperature of the spray drying step is between 125° C. and 165° C. In one more particular embodiment of any of the above embodiments, the inlet temperature is 250° C. and the outlet temperature is 125° C.

### BRIEF DESCRIPTION OF THE DRAWINGS

FIG. 1 is a flowchart illustrating a method of preparing a flux agent.

FIG. 2 illustrates a comparison of the respective morphologies of Ex. 1 and Comp. Ex. 1 described in the Examples section.

Corresponding reference characters indicate corresponding parts throughout the several views. The exemplifications set out herein are provided to illustrate certain exemplary embodiments and such exemplifications are not to be construed as limiting the scope in any manner.

### DETAILED DESCRIPTION

### I. General Description

The present disclosure provides a free flowing flux agent (e.g., for plasma flux applications). The flux agent is formed by mixing and reacting raw materials including aluminum oxide (Al₂O₃), aqueous hydrofluoric acid (HF), and aqueous potassium hydroxide (KOH) as discussed below. The flux agent is also free flowing and has a resistance to caking without the addition of organic additives as have been previously used. Moreover, the flux agent has improved particle morphology and flow characteristics.

As shown below, a flux agent of the present disclosure includes potassium aluminum fluoride (hereinafter KAlF₄) and is produced by the series of reactions shown below.

Al₂O₃+8HF→2HAlF₄+3H₂O (I)

HAlF₄+KOH→KAlF₄+H₂O (II)

As shown above, reaction I includes reacting aluminum oxide with aqueous hydrofluoric acid to create the reaction intermediate of HAlF₄. The reaction intermediate HAlF₄ is then neutralized with aqueous potassium hydroxide resulting in a potassium aluminum fluoride (KAlF₄) precursor and water as shown in reaction II. The KAlF₄ precursor is then isolated by spray drying the reaction mixture resulting in a free-flowing KAlF₄ as discussed further herein.

Exemplary free flowing KAlF₄ has a potassium to aluminum to fluorine ratio that may be as little as 1.0:1.0:4.0, 1.1:1.0:4.1, as great as 1.2:1.0:4.4, 1.3:1.0:4:5, or within any range defined between any two of the foregoing values such as 1.1 to 1.2:1.0:4.0 to 4.2. The ratio varies based on the amounts of raw materials (aluminum oxide, hydrofluoric acid, and potassium hydroxide) used in method 100 as described herein. In an exemplary embodiment, the potassium to aluminum to fluorine ratio is 1.2:1:4.1.

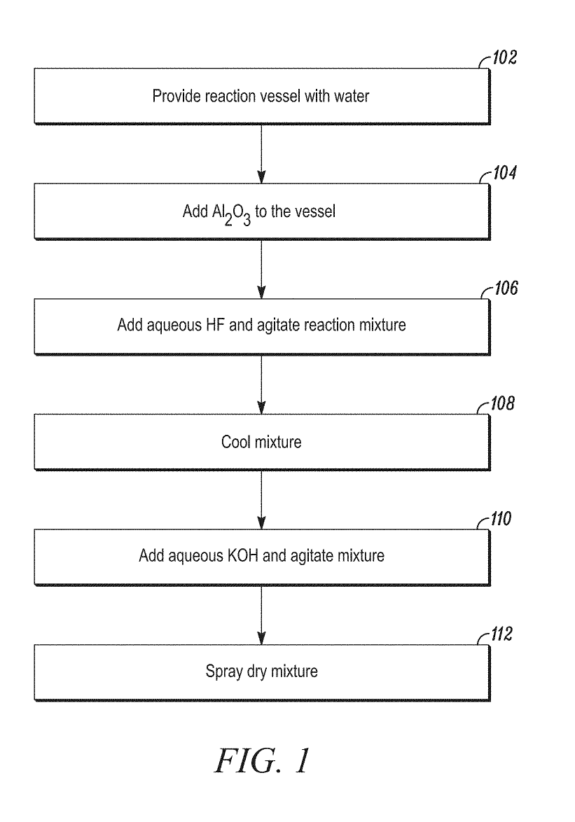

Referring now to FIG. 1, a method 100 to create free flowing KAlF₄ is provided. At block 102, a reaction vessel, such as a beaker, is provided with water. Although not so limited, in one specific embodiment, 250 grams of water is provided in the reaction vessel.

At block 104, powdered aluminum oxide is added to the reaction vessel and is suspended in the water provided in block 102 via agitation. In an exemplary embodiment, 48.9 grams of aluminum oxide is added to the reaction vessel. As mentioned earlier, the reaction mixture provided in block 104, is maintained by agitation.

At block 106, aqueous hydrofluoric acid is added to the suspension within 30 minutes to form a reaction mixture. Aqueous hydrofluoric acid may have a concentration (based on weight percentage) as little as 50 wt. %, 55 wt. %, 60 wt. %, as great as 70 wt. %, 72 wt. %, 74 wt. %, 76 wt. % or within any range defined between any two of the foregoing values, such as between 50 wt. % and 76 wt. %. In an exemplary embodiment, the concentration (based on weight percentage) of the aqueous hydrofluoric acid is 50 wt. %. As the exothermic reaction proceeds and the HAlF₄ intermediate is produced, the temperature of the reaction mixture increases to as little as about 50° C., about 60° C., about 70° C., as great as about 80° C., about 90° C., about 100° C., or within any range defined between any two of the foregoing values such as between 70° C. and 80° C. In an exemplary embodiment, the temperature within the mixture is between 70° C. and 80° C.

When the HF addition is completed, the reaction mixture is agitated at an elevated temperature. An exemplary temperature of the reaction mixture may be as little as 70° C., 72° C., 74° C., as great as 76° C., 78° C., 80° C., or within any range defined between any two of the foregoing values such as between 70° C. and 80° C. The reaction mixture may be stirred for additional time as up to 60 minutes. In an exemplary embodiment, the reaction mixture is stirred for an additional 30 minutes. In an exemplary embodiment, the temperature is between about 70° C. and 80° C. for an additional 15 minutes.

Method 100 then proceeds to block 108 where the reaction mixture of block 106 is cooled. The reaction mixture is cooled to a temperature as little as 40° C., 45° C., 50° C., as great as 60° C., 65° C., 70° C., or within any range defined between any two of the foregoing values such as between 50° C. and 60° C. In an exemplary embodiment, the temperature to which the reaction mixture is cooled is between about 50° C. and 60° C.

Once the reaction mixture is cooled, method 100 then proceeds to block 110 where aqueous potassium hydroxide is added at a high flow rate within minutes of completion of block 108. Aqueous potassium hydroxide can be added via a dropping funnel or an additional dosing unit. Aqueous potassium hydroxide may be added at a rate as little as 10 grams per minute (g/min), 11.5 g/min, 12 g/min, 12.5 g/min, 12.8 g/min, 13 g/min as great as 100 g/min, 150 g/min, 200 g/min, 250 g/min, 300 g/min or within any range defined between any two of the foregoing values. In an exemplary embodiment, the flow rate of aqueous potassium hydroxide is 11.9 g/min. The temperature of aqueous potassium hydroxide may also be decreased before addition. Without wishing to be held to a particular theory, it is believed that the addition of potassium hydroxide over a short period of time (i.e., at a faster rate) at a decreased temperature results in the different morphology and improved flow behavior without the addition of organic additives. By fast addition, it is believed that the crystallization conditions of KAlF₄ are altered such that spherical free-flowing KAlF₄ particles are obtained after spray drying.

Aqueous potassium hydroxide may have a concentration (based on weight percentage) as little as 45 wt. %, 46 wt. %, 47 wt. %, as great as 48 wt. %, 49 wt. %, 50 wt. % or within any range defined between any two of the foregoing values, such as between 45 wt. % and 50 wt. %. In an exemplary embodiment, the concentration (based on weight percentage) of the aqueous potassium hydroxide is 49.8 wt. %. Concentration of aqueous potassium hydroxide indirectly affects the free-flowing KAlF₄ via the rate of addition of aqueous potassium hydroxide as described further below. The amount of aqueous potassium hydroxide added may be as little as 80 grams, 82 grams, 84 grams, as great as 86 grams, 88 grams, or 90 grams, or within any range defined between any two of the foregoing values. In an exemplary embodiment, 83.2 grams of aqueous potassium hydroxide is added to the reaction vessel.

At this point, KAlF₄ precursor precipitates within the reaction mixture. Due to the exothermic reaction, the temperature within the reaction mixture increases to as little as 60° C., 70° C., 80° C., as great as 90° C., 95° C., 100° C., or within any range defined between any two of the foregoing values such as between 60° C. and 100° C. or between 75° C. and 85° C. The reaction mixture may be stirred for 10 minutes to 60 minutes at an elevated temperature. In an exemplary embodiment, the temperature to which the reaction mixture is increased is about 80° C. and the reaction mixture is stirred for an additional 30 minutes.

At block 112, the KAlF₄ precursor is isolated via spray drying to form free-flowing KAlF₄. During spray drying, the inlet temperature may be as little as 250° C., 275° C., 300° C., as great as 375° C., 400° C., 420° C., or within any range defined between any two of the foregoing values such as between 250° C. and 420° C. The outlet temperature may be as little as 125° C., 135° C., 145° C., as great as 155° C., 160° C., 165° C., or within any range defined between any two of the foregoing values such as between 125° C. and 165° C. In an exemplary embodiment, the inlet temperature is 250° C., and the outlet temperature is 125° C. Both nozzles and rotary discs can be used to atomize the reaction mixture for spray drying. The reaction mixture (KAlF₄ precursor) is fed to the spray dryer at a temperature between 20° C. and 60° C.

### II. Properties of Flux Agent

Organic additives are usually used to prevent caking of flux agents as organic additives cover the surface of the flux agents resulting in a smooth, more spherical morphology of the particles.

The free flowing KAlF₄ flux agent produced herein does not include organic additives. Instead, the production parameters of KAlF₄ are adjusted such that the spray dried product obtains the aforementioned free flowing properties. The temperature of the aqueous HAlF₄ is decreased and the rate of addition of potassium hydroxide is increased to obtain the free-flowing properties of KAlF₄. Moreover, the free flowing KAlF₄ flux agent avoids additional processing steps to modify the surface of the material by organic additives, and thereby, the user saves material costs, operational costs, and time.

In addition, the production process does not include organic additives or carbon compounds. Therefore, the free flowing KAlF₄ flux agent has negligible Volatile Organic Compound (VOC) and Total Organic Carbon (TOC) levels, if detectable. Also, hazards arising from handling organic compounds are avoided.

Furthermore, free flowing KAlF₄ flux agent has a more rounded particle morphology and better flowing behavior compared to prior flux agents with organic additives as discussed further herein. In particular, the free flowing KAlF₄ flux agent has a substantially spherical morphology and a diameter as little as 5 microns, 10 microns, 20 microns, 40 microns, as great as 60 microns, 80 microns, 100 microns or within any range defined between any two of the foregoing values. In another embodiment, the free flowing KAlF₄ flux agent has a slight oval shape. The free flowing KAlF₄ flux agent may have an aspect ratio of 1:0.8, 1:0.9, 1:1, 1:1.1, or 1:1.2.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### III. Examples

### Preparation of Example 1

To prepare Example 1, 48.9 grams of aluminum oxide (Al₂O₃) were added to a beaker and suspended in 250 grams of water. Then, 101.4 grams of aqueous hydrofluoric acid (50 wt. % solution in water) were added within 30 minutes to the stirred reaction mixture. As the reaction produces HAlF₄, the temperature of the reaction mixture increased to about 80° C. Once the addition of HF was completed, the reaction mixture was stirred for an additional 15 minutes at a temperature between 70° C. and 80° C.

The reaction mixture was then cooled to between about 50° C. and 60° C. at which point, 83.2 grams of aqueous potassium hydroxide (KOH, 49.8 wt. % solution in water) are added within 7 minutes (flow rate of about 11.9 g/min). At this point, KAlF₄ precipitated from the reaction mixture. The temperature was then increased to about 80° C., and the reaction mixture was stirred for additional 30 minutes.

The product was then isolated via spray drying according to where the inlet temperature was 250° C. and the outlet temperature was 125° C.

Preparation of Comparative Example 1 (Comp. Ex. 1)

To prepare Comp. Ex. 1, 49.2 grams of aluminum oxide (Al₂O₃) were added to a beaker and suspended in 250 grams of water. Then, 101.4 grams of aqueous hydrofluoric acid (50 wt. % solution in water) were added within 30 minutes to the stirred reaction mixture. As the reaction produced HAlF₄, the temperature of the reaction mixture increased to about 80° C. When HF addition was completed, the reaction mixture was stirred for an additional 15 minutes at a temperature between 70° C. and 80° C.

The reaction mixture was cooled to about 60° C., and then 83.2 grams of aqueous potassium hydroxide (KOH, 49.8 wt. % solution in water) were added slowly within 25 minutes (flowrate of about 3.3 g/min). At this point, KAlF₄ precipitated from the reaction mixture. The temperature was then increased to about 80° C. and the reaction mixture was stirred for additional 30 minutes.

The product was then isolated via spray drying where the inlet temperature was 250° C. and the outlet temperature was 125° C.

### Comparison Between Comp. Ex. 1 and Ex. 1

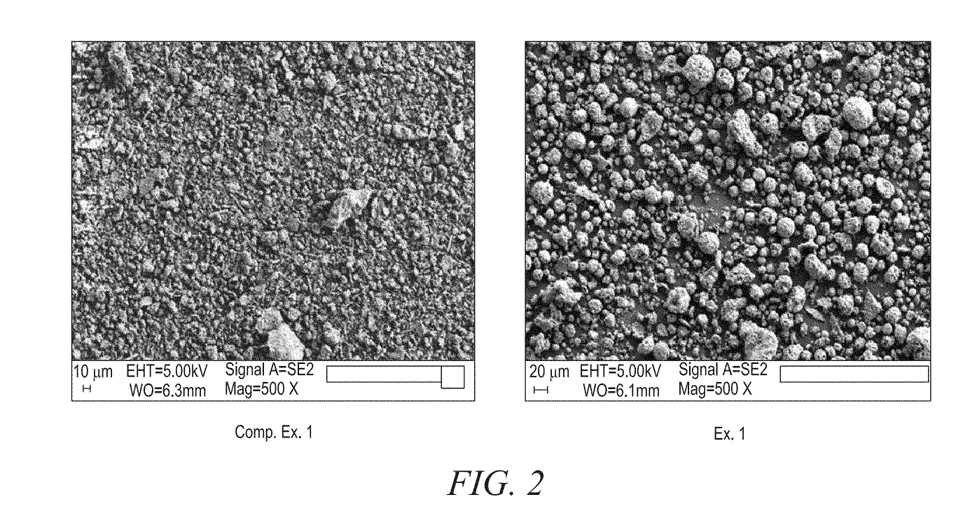

Referring to FIG. 2, a comparison of the morphologies of Comp. Ex. 1 and Ex. 1 are shown. The images were obtained using a Scanning Electron Microscope (SEM) at a 500× magnification and an EHT voltage level of 5 kV. The image of Comp. Ex. 1 is scaled to 10 μm, and the image of Ex. 1 is scaled to 20 μm. As shown, Comp. Ex. 1 has an irregular morphology as compared to Ex. 1, which has a general spherical morphology. The differences in shape are apparent when comparing the flow behaviors of Comp. Ex. 1 and Ex. 1.

The flow behavior of Comp. Ex. 1 and Ex. 1 was tested using a metal funnel according to DIN EN ISO 6186. The metal funnel is closed on the bottom and filled with the powder to be tested (i.e., Comp. Ex. 1 or Ex. 1). A bottom hole was then opened in the metal funnel, and when the hole was opened, the powder of Ex. 1 uniformly flowed out of the funnel within seconds while the material of Comp. Ex. 1 adhered to the funnel and needed further agitation (e.g., tapping on the funnel) to incrementally exit the metal funnel.

Without wishing to be held to a particular theory, it is believed that the addition of potassium hydroxide over a short period of time (i.e., at a faster rate) at a decreased temperature results in the different morphology and improved flow behavior without the addition of organic additives. By fast addition, it is believed that the crystallization conditions of KAlF₄ are altered such that spherical free-flowing KAlF₄ particles are obtained after spray drying.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

1. A KAlF₄ flux agent in the form of particles each having a rounded morphology with a diameter between 5 microns and 100 microns.

2. The flux agent of claim 1, wherein the flux agent has a substantially spherical morphology.

3. A method of producing a flux agent, comprising:
providing a reaction vessel containing water;
adding aluminum oxide to the reaction vessel under agitation;
adding an aqueous hydrofluoric acid to form a reaction mixture, the aqueous hydrofluoric acid having a concentration between 50 wt. % and 76 wt. %;
cooling the reaction mixture to between 40° C. and 70° C.;
adding an aqueous potassium hydroxide to the reaction mixture, wherein the aqueous potassium hydroxide has a concentration between 45 wt. % and 50 wt. %, wherein the potassium hydroxide is added to the reaction mixture at a flow rate between 10 g/min and 300 g/min; and
spray drying the reaction mixture to produce the flux agent.

4. The method of claim 3, wherein adding the aqueous hydrofluoric acid increases the temperature of the reaction mixture to between 50° C. and 100° C.

5. The method of claim 3, wherein the temperature of the reaction mixture is decreased to between 40° C. and 70° C. before adding the potassium hydroxide.

6. The method of claim 3, wherein adding the aqueous potassium hydroxide increases the temperature of the reaction mixture to between 60° C. and 100° C.

7. The method of claim 6, wherein adding the aqueous potassium hydroxide increases the temperature of the reaction mixture to about 80° C.

8. The method of claim 3, wherein an inlet temperature of the spray drying step is between 250° C. and 420° C. and an outlet temperature of the spray drying step is between 125° C. and 165° C.

9. The method of claim 8, wherein the inlet temperature is 250° C. and the outlet temperature is 125° C.

10. A method of producing a flux agent, comprising:
providing a reaction vessel with water;
adding aluminum oxide to the water and agitating the water and the aluminum oxide in the reaction vessel;
adding an aqueous hydrofluoric acid to form a reaction mixture, wherein the temperature of the reaction mixture increases to between 50° C. and 100° C.;
cooling the reaction mixture to between 40° C. and 70° C.;
adding an aqueous potassium hydroxide to the reaction mixture, wherein the potassium hydroxide is added at a flow rate between 11 g/min and 13 g/min, and wherein the temperature of the reaction mixture is increased to between 75° C. and 85° C.; and
spray drying the reaction mixture to produce the flux agent.

11. The method of claim 10, wherein the aqueous hydrofluoric acid has a concentration between 50 wt. % and 76 wt. %; and
wherein the aqueous potassium hydroxide has a concentration between 45 wt. % and 50 wt. %.

12. The method of claim 11, wherein the aqueous hydrofluoric acid has a concentration of 50 wt. % and the aqueous potassium hydroxide has a concentration of 49.8 wt. %.

13. The method of claim 10, wherein adding the aqueous potassium hydroxide increases the temperature of the reaction mixture to about 80° C.

14. The method of claim 10, wherein an inlet temperature of the spray drying step is between 250° C. and 420° C. and an outlet temperature of the spray drying step is between 125° C. and 165° C.

15. The method of claim 14, wherein the inlet temperature is 250° C. and the outlet temperature is 125° C.
